(19) United States
(12) Patent Application Publication
(10) Pub. No.: US 2014/0315532 A1
(43) Pub. Date: Oct. 23, 2014

(54) METHOD AND APPARATUS FOR INFORMATION TRANSMISSION

(71) Applicant: Tencent Technology (Shenzhen) Company Limited, Shenzhen (CN)

(72) Inventor: Liu Yang, Shenzhen (CN)

(73) Assignee: Tencent Technology (Shenzhen) Company Limited, Shenzhen (CN)

(21) Appl. No.: 14/287,664

(22) Filed: May 27, 2014

Related U.S. Application Data
(63) Continuation of application No. PCT/CN2013/089736, filed on Dec. 17, 2013.

(30) Foreign Application Priority Data
Apr. 17, 2013 (CN) 201310133818.6

(51) Int. Cl. H04W 4/14; H04M 1/725; H04W 24/04

(52) U.S. Cl. CPC H04W 4/14; H04W 24/04; H04M 1/72563
USPC 455/418; 455/550.1

(57) ABSTRACT

The invention can be applied to the field of communication, and provides a method and apparatus for information transmission. The method includes: detecting call status changing information of a voice call module; determining whether the call status changing information is failure information; selecting a communication number of a current callee, if the call status changing information is the failure information; triggering an edit mode in a SMS module and setting the communication number of the selected callee as a SMS recipient. As a consequence, a user can automatically enter the edit mode of the SMS module once the call fails and also automatically acquire the communication number of the current callee as the recipient number. The complex operations of switching to the SMS module and looking for the contact number can be avoided, the efficiency of information transmission is increased and meanwhile convenient user operations can be achieved.

### CROSS-REFERENCE TO RELATED APPLICATIONS

This application is a continuation application of International Application PCT/CN2013/089736 filed on Dec. 17, 2013, which claims the priority benefit of Chinese Patent Application No. 201310133818.6 filed on Apr. 17, 2013, the disclosures of which are incorporated by reference herein in their entirety for all intended purposes.

### FIELD OF THE INVENTION

The invention relates to a communication field, and particularly, to a method and apparatus for information transmission.

### BACKGROUND

As the development of communication technology, cell phones have become commonly used communication tools which provide significant convenience for people to contact with each other. People can conveniently transmit text information and voice information by making calls or sending SMS messages.

The advantage of transmitting information by using phone calls is high communication efficiency, but it is required to establish a connection between both parties of the phone call. The advantage of communicating by using short message service (SMS) is that as long as the cell phone for receiving information is powered on, the information can be received, thus, user can immediately read the information sent by the other party of the communication once the user finds his/her cell phone.

When a callee (the party being called) doesn't answer a call in time, a caller (the party making the call) usually switches from a call mode to a SMS mode in order to send messages to the callee in time. The caller firstly exits the current call module, opens the SMS module, enters the new SMS mode, finds the receiver's phone number, and then edits the message and sends to the callee through SMS. The whole operational process is relatively complex and inconvenient for conducting efficient information transmission.

### SUMMARY OF THE INVENTION

It is an object of an embodiment of the invention to provide a method and apparatus for information transmission, in order to solve the problem of complex operations when it is needed to switch from a call mode to a short message service (SMS) mode in the prior art, to increase the efficiency of information transmission and allow convenient operations for users.

An embodiment of the invention can be implemented by a method for information transmission, comprising the steps of:
detecting call status changing information of a voice call module;
determining whether the call status changing information is failure information; selecting a communication number of a current callee, if the call status changing information is the failure information; and
triggering an edit mode of a SMS module and setting the selected communication number of the callee as a SMS recipient.

It is another object of an embodiment of the invention to provide an apparatus for information transmission, comprising:
call status changing information detecting means for detecting call status changing information of a voice call module;
call status changing information determining means for determining whether the call status changing information is failure information;
communication number selecting means for selecting a communication number of a current callee if the call status changing information is the failure information;
SMS mode triggering means for triggering an edit mode of a SMS module and setting the selected communication number of the callee as a SMS recipient.

In an embodiment of the invention, when it is detected that status information of a voice call module has changed, it is determined whether the call status changing information is failure information. If the call status changing information is the failure information, a communication number of a current callee is selected, an edit mode of a SMS module is triggered, and the selected communication number of the callee is set as a SMS recipient, so that the user can automatically enter the edit mode of the SMS module once the call fails and also automatically acquire the communication number of the current callee as the recipient number. As such, the complex operations of switching to the SMS module and looking for the contact number can be avoided, the efficiency of information transmission can be increased and meanwhile convenient user operations can be achieved.

### DESCRIPTION OF THE DRAWINGS

FIG. 1 is a flow diagram showing an implementation of information transmission according to a first embodiment of the invention;

FIG. 2 is a flow diagram showing an implementation of information transmission according to a second embodiment of the invention;

FIG. 3 is a flow diagram showing an implementation of information transmission according to a third embodiment of the invention;

FIG. 4 is a flow diagram showing an implementation of information transmission according to a fourth embodiment of the invention;

FIG. 5 is a structure schematic diagram showing an apparatus for information transmission according to a fifth embodiment of the invention.

### DETAILED DESCRIPTION

In order to make the objects, technical solutions and advantages of the invention more apparent, the invention will be further illustrated in details in connection with accompanying figures and embodiments hereinafter. It should be appreciated that the detailed embodiments described herein are only used to explain the invention but not to limit the invention.

In an embodiment of the invention, when it is detected that status information of a voice call module has changed, it is determined whether the call status changing information is failure information. If the call status changing information is the failure information, a communication number of a current callee is selected, an edit mode of a SMS module is triggered, and the selected communication number of the callee is set as a SMS recipient, so that the user can automatically enter the edit mode of the SMS module once the call fails and also automatically acquire the communication number of the current callee as the recipient number. As such, the complex operations of switching to the SMS module and looking for the contact number can be avoided, the efficiency of information transmission can be increased and meanwhile convenient user operations can be achieved. In order to further improve usability, contact persons in a same contact group as the callee can be searched in the caller's contacts and can be set as the SMS recipients, so as to improve convenience of simultaneously transmitting messages to multiple persons. Additionally, for the purpose of reducing the user's effort, the name of the contact person recorded in the caller's contacts which corresponds to the communication number of the current callee can be acquired and copied into the SMS content area under the SMS edit mode, so as to improve the efficiency of editing SMS messages.

### Embodiment I

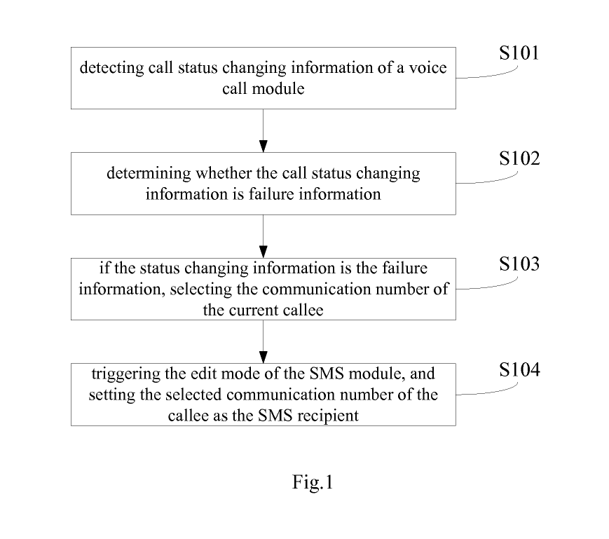

FIG. 1 is a flow diagram showing an implementation of information transmission according to the first embodiment of the invention. The detailed description is provided below.

At step S101, call status changing information of a voice call module is detected.

More specifically, the voice call module is mainly used in communication devices such as cell phones, to receive an input communication number, initiate a call request, establish a call connection, release a call connection, and so on. The status changing information of the voice call module may include the changing information about the status of call initiation, call response, establishment of a call connection, release of a call connection and the like.

At step S 102, it is determined whether the call status changing information is failure information.

The failure information as recited in the embodiments of the invention may include call rejection (the callee refuses to answer), off hook (the callee is calling right now), no answer (the callee does not answer), powered off (the callee's device is powered off), not in service (the callee is not in a service area) and short call duration time.

As an example, suppose caller A initiates a call request to callee B, a possible consequence can be: 1) callee B is currently not available to answer the call, e.g. callee B is in a meeting, and then caller A receives a response of call rejection from callee B; 2) callee B is currently in another call, and then caller A receives a response of callee being off hook from the callee; 3) callee B currently does not answer the call, and caller A receives a response of no answer; 4) callee B has turned off his/her phone or is not in service area, and caller A receives a response of not being able to establish a call connection.

In addition, the failure information is not limited to call failure, it should be broadly understood. For example: 5) caller A and callee B establish a call, but because the signal quality is poor, the call only lasts 3, 4 seconds; 6) caller A and callee B establish a call, but callee B tells caller A to send a short message concerning the needed information after callee B answers the call, then callee B hangs up the phone. Under these 2 circumstances, the call duration time is short, caller A and callee B cannot communicate sufficiently, the circumstances are both within the failure information of the invention.

Concerning short call duration time, the criteria may be different depending on different languages, but generally, the call duration time should be less than 1 minute to be deemed as short.

The above-mentioned failure information can be detected and determined by interpreting the response returned by callee B.

At step S103, if the status changing information is the failure information, the communication number of the current callee may be selected.

If the status changing information is the failure information as mentioned in the above step S102, the recently dialed communication number, which is generally a cell phone number, can be selected from the call record of the voice call module.

At step S104, the edit mode of the SMS module is triggered, and the selected communication number of the callee is set as the SMS recipient.

When the status changing information is the failure information, the edit mode of the SMS module is triggered, that is, it is possible to directly enter a SMS interface capable of receiving the SMS content input by the user, and then the recorded communication number of the callee is set as the SMS recipient.

### Embodiment II

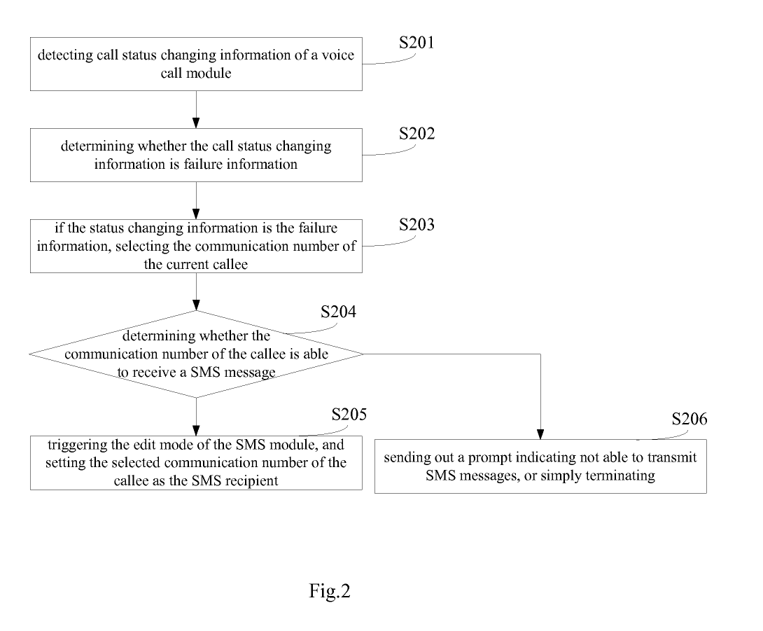

FIG. 2 is a flow diagram showing an implementation of information transmission including the operation of determining the communication number, according to the second embodiment of the invention. The detailed description is provided below.

At step S201, call status changing information of a voice call module is detected.

At step S202, it is determined whether the call status changing information is failure information.

At step S203, if the status changing information is the failure information, the communication number of the current callee may be selected.

At step S204, it is determined whether the communication number of the callee is able to receive a SMS message, by matching the communication number of the callee in accordance with a predefined feature library of communication numbers. If the communication number of the callee is able to receive the SMS message, the step S205 will be executed. Otherwise, the step S206 will be executed.

More specifically, the callee's communication number may include either a cell phone number or a fixed-line telephone number. In order to avoid invalid invoke of system resource, a match of communication numbers can be conducted before the SMS module is triggered. For example, for cell phone numbers such as those starting with numbers of “130”, “131”, etc, the SMS module may be triggered, while for numbers starting with an area code such as “0755”, etc, which are recognized as fixed-line telephone numbers, the SMS module may not be triggered.

The above-mentioned example applies to China. In China, the numbers starting with “130” are mobile phone numbers, and the numbers starting with “0755” are fixed-line telephone numbers. In other countries there are other rules relating to telephone numbers. The invention can apply to all these rules.

At step S205, the edit mode of the SMS module is triggered, and the selected communication number of the callee is set as the SMS recipient.

At step S206, the communication number of the callee is not able to receive SMS messages, and thus a prompt indicating not able to transmit SMS messages can be sent out or the process can be simply terminated.

The difference between the present embodiment and the first embodiment is that in the present embodiment, with the operation of matching the communication number of the callee, mistakenly triggering the operation of the SMS module can be prevented, and thus the utilization efficiency of the system resource can be increased.

### Embodiment III

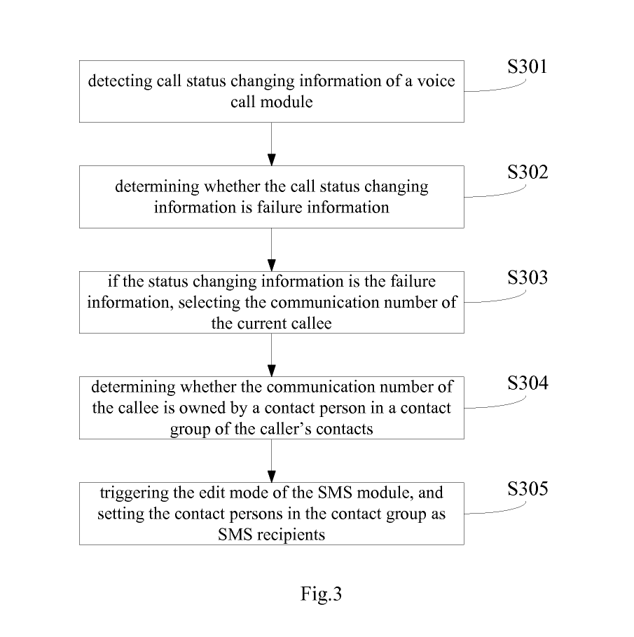

FIG. 3 is a flow diagram showing an implementation of information transmission in which a plurality of contact persons can be simultaneously selected to transmit SMS messages, according to the third embodiment of the invention. The detailed description is provided below.

At step S301, call status changing information of a voice call module is detected.

At step S302, it is determined whether the call status changing information is failure information.

At step S303, if the status changing information is the failure information, the communication number of the current callee may be selected.

At step S304, it is determined whether the communication number of the callee is owned by a contact person in a contact group of the caller's contacts.

At step S305, the edit mode of the SMS module is triggered, and the contact persons in the contact group (which includes the callee) of the caller's contacts are set as SMS recipients.

More specifically, communication numbers dialed by the caller may belong to a specific group of the caller's contacts, such as “relatives”, “college classmates”, “high school classmates”, “natives”, etc. In order to improve the intelligence of information transmission, the contact persons in the contact group (which includes the callee) of the caller's contacts can be set as SMS recipients after the failure information is received. Before setting the contact persons in the contact group as recipients, a prompt information can be sent out to the user for getting the user's confirmation, so the operation is optional to the user.

The difference between the present embodiment and the first embodiment is that in the present embodiment, the contact persons in the contact group (which includes the callee) of the caller's contacts can be set as SMS recipients, so that users can conveniently perform the operation of fast group messaging, and thus the convenience and operational efficiency of information transmission can be improved.

### Embodiment IV

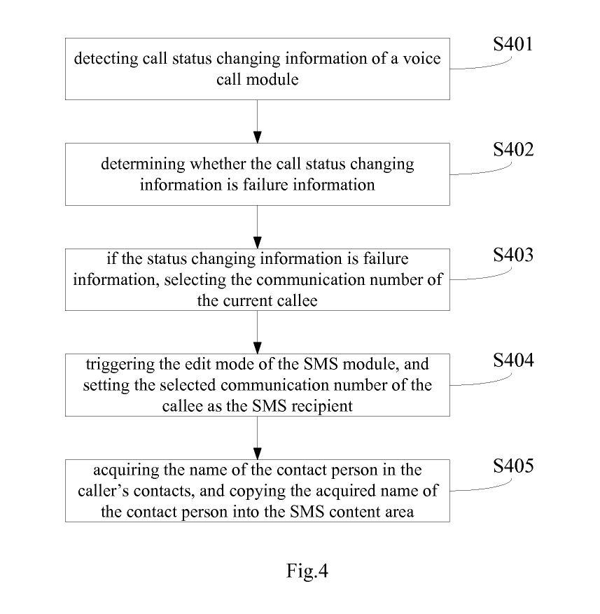

FIG. 4 is a flow diagram showing an implementation of information transmission according to the fourth embodiment of the invention. The detailed description is provided below.

At step S401, call status changing information of a voice call module is detected.

At step S402, it is determined whether the call status changing information is failure information.

At step S403, if the status changing information is failure information, the communication number of the current callee may be selected.

At step S404, the edit mode of the SMS module is triggered, and the selected communication number of the callee is set as the SMS recipient.

At step S405, it is determined whether the communication number of the current callee is present in the caller's contacts. If yes, the name of the contact person in the caller's contacts which corresponds to the communication number of the current callee is acquired, and the acquired name of the contact person is copied into the SMS content area under the SMS edit mode.

More specifically, when a user makes a dialing operation, some numbers may be the numbers input by the user, and some numbers may be the numbers directly obtained by looking up the user's contacts. If the callee's number is present in the caller's contacts, the name of the current callee in the caller's contacts can be copied into the SMS content, to increase the user's input efficiency.

The difference between the present embodiment and the first embodiment is that in the present embodiment, the name of the contact person in the contacts can be directly imported into the SMS content, which makes it easier for users to input the SMS content without inputting extra name information.

### Embodiment V

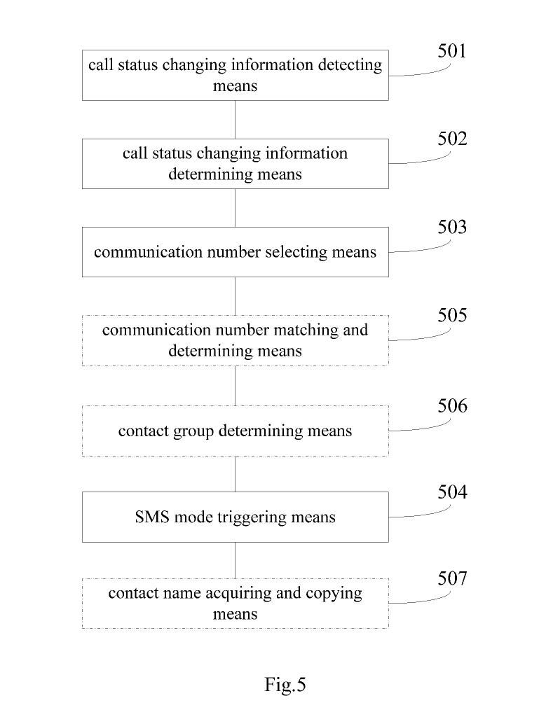

FIG. 5 is a structure schematic diagram showing an apparatus for information transmission according to a fifth embodiment of the invention. The detailed description is provided below.

The apparatus for information transmission according to the present embodiment of the invention includes: call status changing information detecting means 501, call status changing information determining means 502, communication number selecting means 503, and SMS mode triggering means 504, wherein
the call status changing information detecting means 501 is configured to detect call status changing information of a voice call module;
the call status changing information determining means 502 is configured to determine whether the call status changing information is failure information; (For example, determining whether the call duration time is lower than a predetermined threshold, if yes, it is considered that it is the failure information of the short call duration time.)
the communication number selecting means 503 is configured to select a communication number of a current callee if the call status changing information is the failure information;
the SMS mode triggering means 504 is configured to trigger an edit mode of a SMS module and set the communication number of the selected callee as a SMS recipient.

In order to further increase the utilization of system resource, the apparatus may also include communication number matching and determining means 505 for determining whether the communication number of the callee is able to receive a SMS message by matching the communication number of the callee in accordance with a predefined feature library of communication numbers.

In order to improve the operational convenience, the apparatus may also include contact group determining means 506 for determining whether the communication number of the callee is owned by a contact person in a contact group of the caller's contacts.

If the communication number of the callee is owned by a contact person in a contact group of the caller's contacts, the SMS mode triggering means 504 is particularly configured to: trigger the edit mode of the SMS module, and set the contact persons in the contact group (which includes the callee) of the caller's contacts as SMS recipients.

In order to increase the user's input efficiency, the apparatus may also include contact name acquiring and copying means 507 which is configured to determine whether the communication number of the current callee is present in the caller's contacts and if yes, acquire the name of the contact person in the caller's contacts which corresponds to the communication number of the current callee, and copy the acquired name of the contact person into the SMS content area under the SMS edit mode.

The failure information as used in the apparatus includes one or more of the followings: call rejection, off hook, no answer, powered off, not in service and short call duration time.

The apparatus embodiments of the invention respectively correspond to the method embodiments as illustrated in the above embodiments I-IV, and thus will not be repeatedly described herein.

The additional technical features in the above second, third and fourth embodiments can be mutually combined so as to improve the efficiency of information transmission and increase the user's operational convenience.

In an embodiment of the invention, when it is detected that status information of a voice call module has changed, it may be determined whether the call status changing information is failure information or not. If the call status changing information is the failure information, a communication number of a current callee may be selected and an edit mode of a SMS module can be triggered, and the communication number of the selected callee can be set as a SMS recipient, so that the user can automatically enter the edit mode of the SMS module once the call fails, and also automatically acquire the communication number of the current callee as the recipient number. As such, the complex operations of switching to the SMS module and looking for the contact number can be avoided, the efficiency of information transmission will be increased and meanwhile convenient user operations can be achieved. In order to further improve usability, contact persons in the same contact group as the callee can be searched in the caller's contacts and can be set as SMS recipients, so as to improve convenience of simultaneously transmitting messages to multiple persons. Additionally, for the purpose of reducing the user's effort, the name of the contact person recorded in the caller's contacts which corresponds to the communication number of the current callee can be acquired and copied into the SMS content area under the SMS edit mode, so as to improve the efficiency of editing SMS messages.

The above described embodiments are merely preferred embodiments of the invention, but not intended to limit the invention. Any modifications, equivalent alternations and improvements that are made within the spirit and scope of the invention should be included in the protection scope of the invention.

What is claimed is:

1. A method for information transmission, wherein the method comprises the steps of:
detecting call status changing information of a voice call module;
determining whether the call status changing information is failure information;
selecting a communication number of a current callee, if the call status changing information is the failure information; and
triggering an edit mode of a SMS module and setting the selected communication number of the callee as a SMS recipient.

2. The method according to claim 1, wherein before the step of triggering the edit mode of the SMS module and setting the selected communication number of the callee as the SMS recipient, the method further comprises:
determining whether the communication number of the callee is able to receive a SMS message by matching the communication number of the callee in accordance with a predefined feature library of communication numbers; and if yes, moving to the next step, otherwise, terminating the method.

3. The method according to claim 1, wherein the method also further comprises:
determining whether the communication number of the callee is owned by a contact person in a contact group of the caller's contacts; and if yes, the step of triggering the edit mode of the SMS module and setting the communication number of the selected callee as the SMS recipient comprises:
triggering the edit mode of the SMS module and setting contact persons in the contact group, which includes the selected callee, of the caller's contacts as SMS recipients.

4. The method according to claim 1, wherein the method further comprises:
determining whether the communication number of the current callee is present in the caller's contacts; and if yes, acquiring a name of a contact person recorded in the caller's contacts which corresponds to the communication number of the current callee, and copying the name of the contact person into a SMS content area under a SMS edit mode.

5. The method according to claim 1, wherein the failure information comprises one or more of the followings: call rejection, off hook, no answer, powered off, not in service and short call duration time.

6. An apparatus for information transmission, wherein the apparatus comprises:
call status changing information detecting means for detecting call status changing information of a voice call module;
call status changing information determining means for determining whether the call status changing information is failure information;
communication number selecting means for selecting a communication number of a current callee, if the call status changing information is the failure information; and
SMS mode triggering means for triggering an edit mode of a SMS module and setting the selected communication number of the callee as a SMS recipient.

7. The apparatus according to claim 6, wherein the apparatus further comprises:
communication number matching and determining means for determining whether the communication number of the callee is able to receive a SMS message by matching the communication number of the callee in accordance with a predefined feature library of communication numbers.

8. The apparatus according to claim 6, wherein the apparatus further comprises:
contact group determining means for determining whether the communication number of the callee is owned by a contact person in a contact group of the caller's contacts;
if yes, the SMS mode triggering means is further configured to trigger the edit mode of the SMS module and set contact persons in the contact group, which includes the selected callee, of the caller's contacts as SMS recipients.

9. The apparatus according to claim 6, wherein the apparatus further comprises:
contact name acquiring and copying means for determining whether the communication number of the current callee is present in the caller's contacts; and if yes, acquiring a name of a contact person recorded in the caller's contacts which corresponds to the communication number of the current callee, and copying the name of the contact person into a SMS content area under a SMS edit mode.

10. The apparatus according to claim 6, wherein the failure information comprises one or more of the followings: call rejection, off hook, no answer, powered off, not in service and short call duration time.
